(19) United States
(12) Patent Application Publication
(10) Pub. No.: US 2001/0034962 A1
(43) Pub. Date: Nov. 1, 2001

(54) Bug-trapping cap

(76) Inventor: Min-Hsien Chang, Chia Yi Hsien (TW)

Correspondence Address: LARSON & TAYLOR, PLC, 1199 NORTH FAIRFAX STREET, SUITE 900, ALEXANDRIA, VA, 22314, US

(21) Appl. No.: 09/801,766

(22) Filed: Mar. 9, 2001

(30) Foreign Application Priority Data
Apr. 28, 2000 (TW) 89,207,133

(51) Int. Cl. A01M 1/20

(52) U.S. Cl. 43/107

(57) ABSTRACT

A bug-trapping cap comprises at least one radial extension extending radially from an outer periphery thereof. The radial extension includes a hollow interior. The hollow interior and a mouth of a bottle together define a zigzag passage when the bug-trapping cap is mounted to the mouth of the bottle such that the mouth of the bottle is not sealed by the bug-trapping cap. The zigzag passage has a downwardly facing opening to allow entrance of bugs and to prevent entrance of rain.

### BACKGROUND OF THE INVENTION

1. Field of the Invention

The present invention relates to a bug-trapping cap, and more particularly to a cap that can be mounted to a mouth of a bottle for trapping bugs into the bottle.

2. Description of the Related Art

FIG. 4 of the drawings illustrates a conventional bug-trapping bottle comprising a bottle 51, a cap 52, and a rain shield 53. The cap 52 includes several vanes 521 with inlets 522 therein for trapping bugs and for preventing entrance of rain. Nevertheless, there are too many members that require to be manufactured according to a proper dimension, which is costly to manufacture, In addition, cleaning for reuse of the bottle is a problem after bugs have been trapped in the bottle.

### SUMMARY OF THE INVENTION

It is the primary object of the present invention to provide a bug-trapping bottle that can be mounted to a mouth of a bottle for trapping bugs. The bottle can be a used one to meet reuse purpose.

A bug-trapping cap in accordance with the present invention is to be mounted to a mouth of a bottle. The bug-trapping cap comprises at least one radial extension extending radially from an outer periphery thereof. The radial extension includes a hollow interior. The hollow interior and a mouth of a bottle together define a zigzag passage when the bug-trapping cap is mounted to the mouth of the bottle such that the mouth of the bottle is not sealed by the bug-trapping cap. The zigzag passage has a downwardly facing opening to allow entrance of bugs and to prevent entrance of rain.

The bug-trapping cap includes an inner threading and the mouth of the bottle includes an outer threading for engaging with the inner threading. The inner threading of the bug-trapping cap may be incontinuous.

In an embodiment of the invention, the bug-trapping cap includes three equi-angularly spaced radial extensions. Each radial extension includes an arcuate opening defined in a side wall thereof that is adjacent to the downwardly-facing opening. The bug-trapping cap is nontransparent and deep-colored.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a bottle and a bug-trapping cap in accordance with the present invention.

FIG. 2 is a top view of the bottle and the bug-trapping cap in FIG. 1, wherein the cap and the mouth of the bottle are sectioned to show interior structure.

FIG. 3 is a sectional view taken along line 3-3 in FIG. 2.

FIG. 4 is an exploded perspective view of a conventional bug-trapping bottle

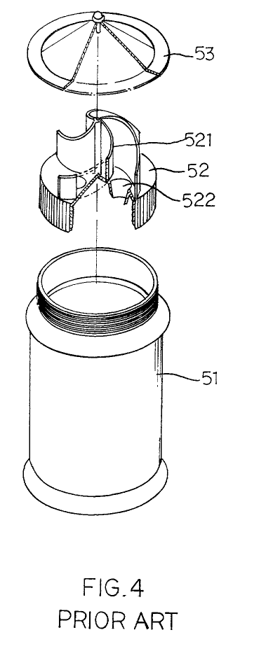

### DETAILED DESCRIPTION OF THE PREFERRED EMBODIMENT

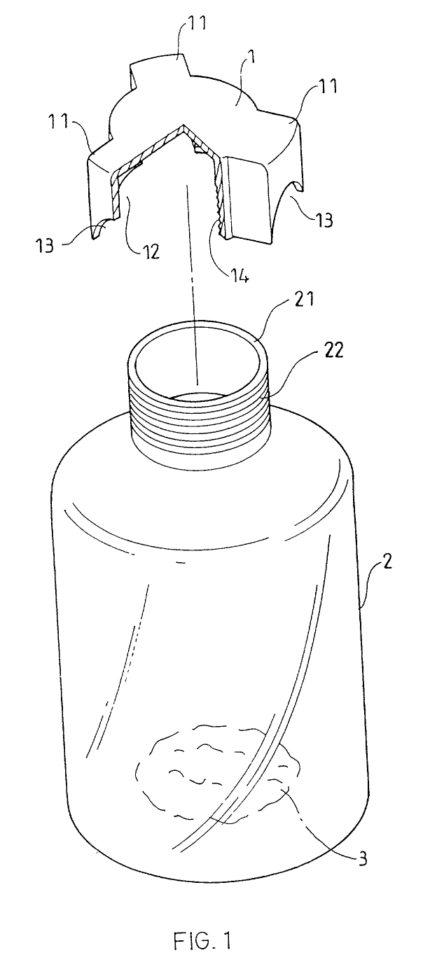

Referring to FIG. 1, a bug-trapping cap 1 in accordance with the present invention can be mounted to a mouth 21 of a bottle 2 that has a bait 3 therein for trapping bugs. The bottle 2 can be a used one to meet reuse purpose. The bait 3 may be sticky to prevent escape of the bugs. Preferably, the mouth 21 of the bottle 2 includes an outer threading 22.

The bug-trapping cap 1 includes at least one radial extension 1 extending radially from an outer periphery thereof. Each radial extension 1 includes a hollow interior 12. In this embodiment, there are three equi-angularly spaced radial extensions 11 for increasing the number of inlets for bugs and for providing easy tightening/loosening of the cap 1. An arcuate opening 13 is defined in a side wall of each radial extension 1. In addition, the bug-trapping cap 1 includes an inner threading 14 for engaging with the outer threading 22 of the mouth 21 of the bottle 2.

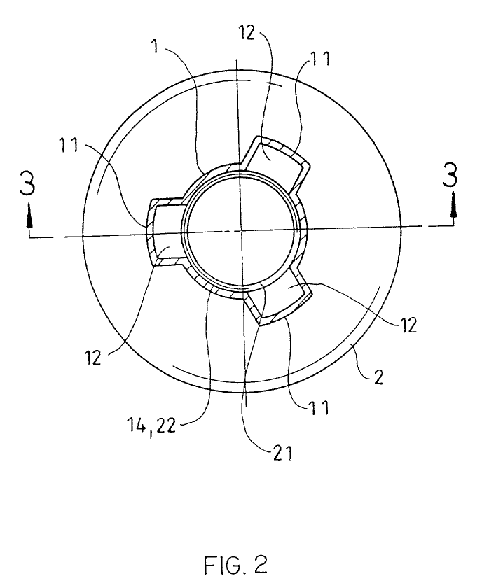

As illustrated in FIG. 2, when the bug-trapping cap 1 is engaged to the mouth 21 of the bottle 2, the radial extensions 11 are located outside the mouth 21 when viewed from top. The hollow interior 12 in each radial extension renders the inner threading 14 incontinuous.

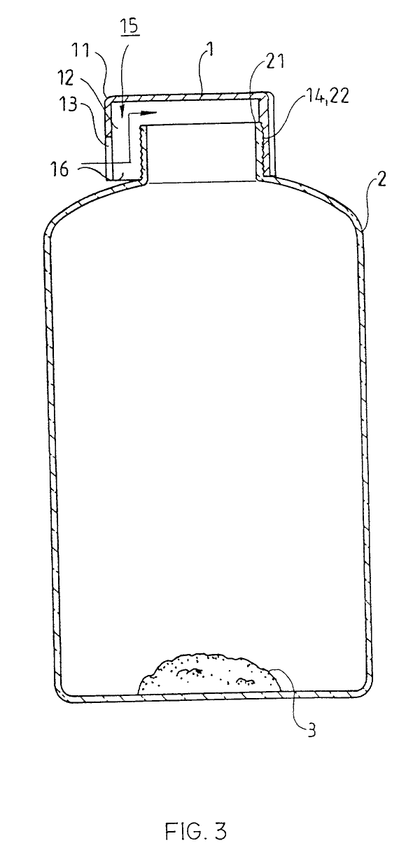

As illustrated in FIG. 3 which is a sectional view taken along line 3-3 in FIG. 2, the hollow interior 12 in each radial extension 11 and the mouth 21 together define a zigzag passage 15 such that the bug-trapping cap 1 cannot seal the mouth 21, thereby allowing entrance of bugs. It is noted that the zigzag passage 15 has a downwardly facing outer opening 16 to prevent entrance of rain. The arcuate opening 13 is defined in a side wall of the respective radial extension 11 adjacent to the respective outer opening 16 to thereby provide an extra inlet for bugs.

The bug-trapping cap 1 is preferably nontransparent and deep-colored, such as black. Bugs 2 trapped in the bottle 2 are mostly stuck in the sticky bait 3. Some of them may get away from the bait 3, yet they will move toward the transparent peripheral wall of the bottle 2 rather than toward the deep colored bug-trapping cap 1. Thus, the bugs cannot escape once they were trapped in the bottle 2. When the bottle 2 is full of bugs or not so efficient for trapping bugs, the bug-trapping cap 1 can be removed from the bottle 2 and then mounted to another used bottle with a bait therein for trapping bugs.

In conclusion, the bug-trapping cap in accordance with the present invention can be mounted to any bottle for trapping bugs. The bug-trapping cap may prevent entrance of rain.

Although the invention has been explained in relation to its preferred embodiment, it is to be understood that many other possible modifications and variations can be made without departing from the scope of the invention as hereinafter claimed.

What is claimed is:

1. A bug-trapping cap adapted to be mounted to a mouth of a bottle, the bug-trapping cap comprising at least one radial extension extending radially from an outer periphery thereof, said at least one radial extension including a hollow interior, the hollow interior and a mouth of a bottle together defining a zigzag passage when the bug-trapping cap is mounted to the mouth of the bottle such that the mouth of the bottle is not sealed by the bug-trapping cap, the zigzag passage having a downwardly-facing opening to allow entrance of bugs.

2. The bug-trapping cap as claimed in claim 1, wherein the bug-trapping cap includes an inner threading and the mouth of the bottle includes an outer threading for engaging with the inner to threading.

3. The bug-trapping cap as claimed in claim 2, wherein the inner threading of the bug-trapping cap is incontinuous.

4. The bug-trapping cap as claimed in claim 1, wherein the bug-trapping cap includes three equi-angularly spaced radial extensions.

5. The bug-trapping cap as claimed in claim 4, wherein each said radial extension includes an arcuate opening defined in a side wall thereof that is adjacent to the downwardly-facing opening.

6. The bug-trapping cap as claimed in claim 5, wherein the bug-trapping cap is nontransparent and deep-colored.
